(19) United States
(12) Patent Application Publication
(10) Pub. No.: US 2022/0283641 A1
(43) Pub. Date: Sep. 8, 2022

(54) KEYBOARDS WITH HAPTIC OUTPUTS

(71) Applicant: Hewlett-Packard Development Company, L.P., Spring, TX (US)

(72) Inventors: Hung-Ming Chen, Taipei City (TW); Charles Stancil, Spring, TX (US); Tai Hsiang Chen, Taipei City (TW); Wei Hung Lin, Taipei City (TW)

(73) Assignee: Hewlett-Packard Development Company, L.P., Spring, TX (US)

(21) Appl. No.: 17/636,059

(22) PCT Filed: Nov. 8, 2019
(86) PCT No.: PCT/US2019/060370

§ 371 Date: Feb. 17, 2022

(51) Int. Cl. G06F 3/01; G06F 3/04886

(52) U.S. Cl. CPC G06F 3/016; G06F 3/04886

(57) ABSTRACT

In one example, an electronic device may include a touch panel defining an input surface having an input region and a display panel disposed below the touch panel. The display panel may visualize a virtual keyboard including a set of virtual keys. Further, the electronic device may include a haptic array module disposed below the display panel. The haptic array module may include a first actuator disposed below the input region corresponding to a first virtual key of the set of virtual keys. Further, the electronic device may include a controller in communication with the haptic array module to trigger the first actuator to generate a haptic output at the input region in response to an activation of the virtual keyboard.

### BACKGROUND

The emergence and popularity of mobile computing has made portable electronic devices, due to their compact design and light weight, a staple in today's marketplace. Notebook and tablet computers are examples of the portable electronic devices that are widely used. Notebook and tablet computers may employ a touchscreen on a display surface of the device that may be used for both viewing and input. Users of such devices may interact with the touchscreen via finger or stylus gestures. As an example, an on-screen keyboard may be provided on the touchscreen surface for entering user inputs. In other examples, notebook and tablet computers may include a dual screen display or a foldable display, in which a touchscreen portion can present a virtual keyboard to accept user inputs.

### BRIEF DESCRIPTION OF THE DRAWINGS

Examples are described in the following detailed description and in reference to the drawings, in which:

FIG. 1A is a cross sectional view of an example electronic device, including a controller to trigger a first actuator to generate a haptic output at a first virtual key;

FIG. 1B is a cross sectional view of the example electronic device of FIG. 1A, depicting additional features;

FIG. 1C depicts an exploded view of the example electronic device of FIG. 1A, depicting an example virtual keyboard;

FIG. 1D depicts an exploded view of the example electronic device of FIG. 1C, depicting customization of virtual keys according to a user preference to generate the haptic output;

FIG. 2A is a cross sectional view of an example electronic device, including a controller to trigger a first actuator to generate a first haptic output at a first key;

FIG. 2B depicts an exploded view of the example electronic device of FIG. 2A, depicting an example keyboard;

FIGS. 2C and 2D illustrate schematic diagrams of a portion of the example electronic device of FIG. 2A, depicting the first actuator to locally deform an input region of a touch screen over the first key;

FIG. 3A illustrates a schematic diagram of an example electronic device (e.g., such as the electronic device shown in FIG. 2A), including dual screens to implement functionalities described in FIG. 2A;

FIG. 3B illustrates a schematic diagram of an example electronic device (e.g., such as the electronic device shown in FIG. 2A), including a foldable display to implement the functionalities described in FIG. 2A;

FIG. 4A is a block diagram of an example electronic device including a non-transitory machine-readable storage medium, storing instructions to trigger a first actuator to generate a first haptic output at an input region based on a user profile;

FIG. 4B is a block diagram of the example electronic device of FIG. 4A, depicting additional features; and

FIG. 5 is an example flow diagram for switching an actuator corresponding to a first virtual key between a typing mode and a pre-haptic mode.

### DETAILED DESCRIPTION

Electronic devices with touch screens may be provided with virtual keyboards. The virtual keyboards may appear to provide flexibility for input scenarios and customization than mechanical keyboards. However, the virtual keyboards may not have physical keys on the touch screens, and hence a user may find it difficult to identify a right typing position on the virtual keyboards. For example, the user may have to look at the virtual keyboard to identify locations of the virtual keys during typing on the virtual keyboard, which can result in poor user experience. In addition, the virtual keyboards may have a flat and inflexible input surface that gives little or no tactile feedback.

Examples described herein may provide an electronic device with a touch screen defining a keyboard. The touch screen may include an input surface having multiple input regions. The keyboard may include a set of keys. Further, the electronic device may include a first actuator disposed below an input region corresponding to a first key of the set of keys. Furthermore, the electronic device may include a controller communicatively connected to the first actuator. In one example, the controller may trigger the first actuator to generate a haptic output at the input region in response to an activation of the keyboard.

In another example, the controller may retrieve a user profile including key information for generating the haptic output. Further, the controller may trigger the first actuator corresponding to the first key to generate the haptic output at the input region when the first key matches with the key information. For example, the controller may retrieve the user profile in response to the activation of the keyboard. Alternatively, the controller may retrieve the user profile in response to detecting a proximity of a user's hand to the keyboard.

Thus, examples described herein may generate the haptic output that enables a user to feel a surface texture on the first key in order to identify alocation of the first key. The first key may act as a reference key to enable the user to type on the keyboard without looking at the keyboard. Further, the first key can be configurable according to a user preference. For example, a user can select key “A” key “S”, key “D”, or the like as the reference key to generate the haptic output. In this example, when the user selects key “A” as the reference key, the controller can trigger a first actuator corresponding to key “A” to generate the haptic output. Similarly, when the user selects key “D” as the reference key, the controller can trigger a second actuator corresponding to key “D” to generate the haptic output.

In other examples, the user can select a subset of the set of keys as reference keys based on a typing pattern. For example, the user can select “ASDF” keys and/or “JKL” keys as the reference keys. In this example, the controller can simultaneously trigger multiple actuators corresponding to the subset of keys to generate the haptic output at the subset of keys, while the remaining keys of the set of keys are in a non-haptic state. Thus, the user can sense the “ASDF” keys and/or “JKL” keys as reference keys and type without looking at the keyboard.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

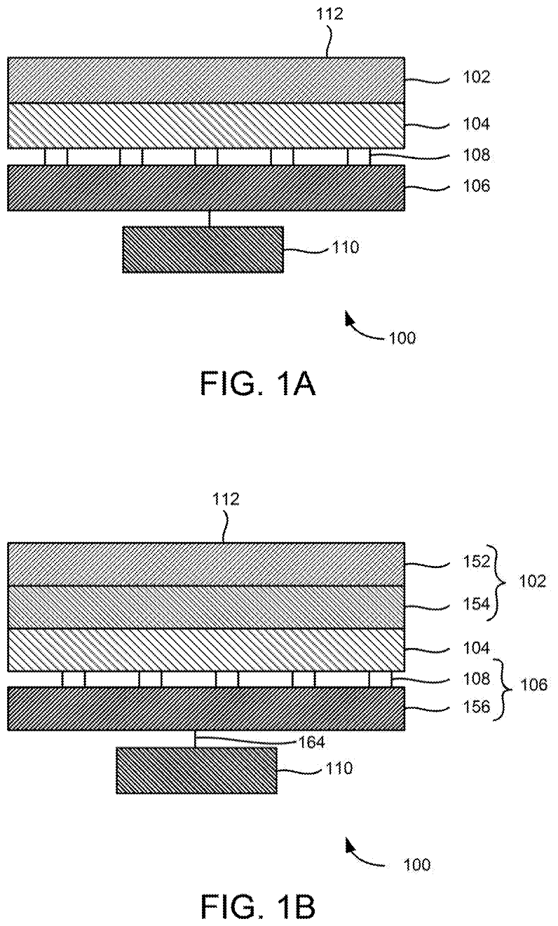

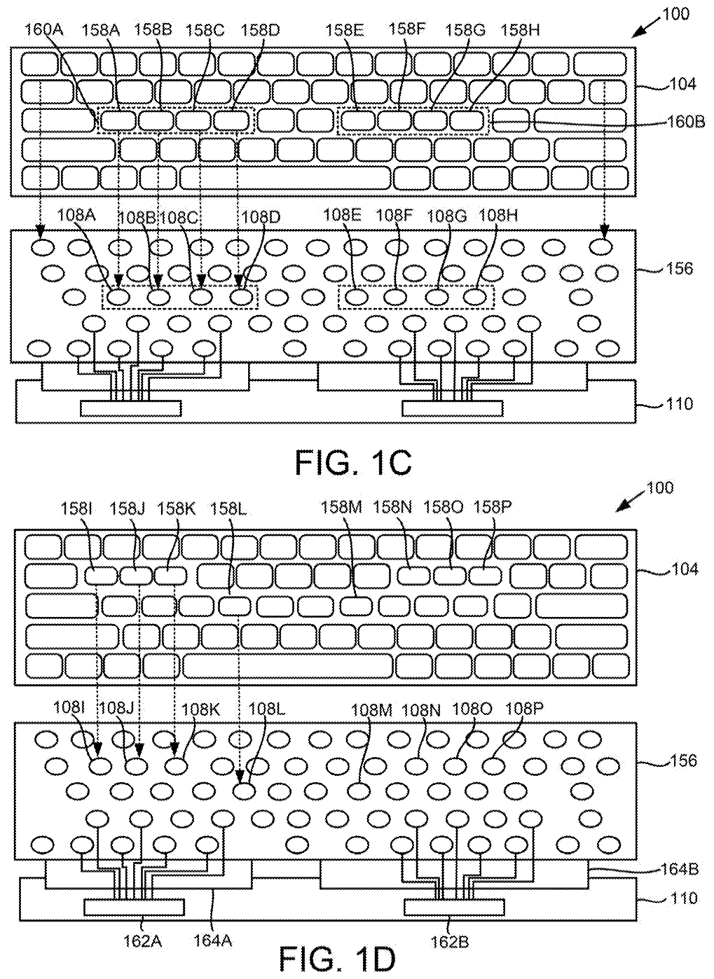

Turning now to the figures, FIG. 1A is a cross sectional view of an example electronic device 100, including a controller 110 to trigger a first actuator 108 to generate a haptic output at a first virtual key. Example electronic device 100 may include a notebook computer, tablet computer, personal computer (PC), gaming laptop, dual screen notebook computer, foldable display device, or the like.

Example electronic device 100 may include a touch panel 102 defining an input surface 112 having an input region. Further, electronic device 100 may include a display panel 104 disposed below touch panel 102. Further, display panel 104 may visualize a virtual keyboard including a set of virtual keys. Example display panel 104 may be a foldable display. For example, display panel 104 may include various display components, such as liquid crystal display (LCD) components, light source(s) (e.g., light emitting diodes (LEDs), organic LEDs (OLEDs)), filter layers, polarizers, light diffusers, covers (e.g., glass or plastic cover sheets), and the like. In some examples, display panel 104 may include a display stack (e.g., including an LCD, polarizing films, light diffusing films, and/or a back or side light). Electronic device 100 may also include other components such as structural components that support any of the above components, batteries, wired or wireless communication components, processors, memory, or the like.

Furthermore, electronic device 100 may include a haptic array module 106 disposed below display panel 104. Haptic array module may include first actuator 108 disposed below the input region corresponding to a first virtual key of the set of virtual keys. Example first virtual key may be a character input key such as an alphanumeric character, symbolic character, text space, tab, or the like. In other examples, the first virtual key may include a control key to control electronic device 100, for instance, to control audio volume, screen brightness, or other device functions.

Also, electronic device 100 may include controller 110 in communication with haptic array module 106. Example controller 110 may be an embedded controller, which may be implemented in hardware, machine-readable instructions, or a combination thereof. For example, controller 110 may be implemented as engines or modules including any combination of hardware and programming to implement the functionalities described herein. For example, controller 110 can be implemented with a microcontroller, an application-specific integrated circuit (ASIC), a programmable gate array (PGA), or the like.

During operation, controller 110 may detect an activation of the virtual keyboard (e.g., turning the virtual keyboard on). When the virtual keyboard is activated, the virtual keyboard is displayed as a graphical element on display panel 104. In this example, a set of individual keys of the virtual keyboard can be shown on display panel 104. In one example, the virtual keyboard may be activated by an operating system of electronic device 100. The activation may be automatic, e.g. by a user accessing a text field on electronic device 100. Alternatively, the activation may be manual, e.g., by a user pressing a button on electronic device 100. In yet another example, the activation may occur when electronic device 100 is switched on. In yet another example, the activation may occur in response to detecting a proximity of the users hand or finger to the virtual keyboard. In these examples, a signal may be sent from the operating system to controller 110 that the virtual keyboard is activated.

Further, controller 110 may trigger first actuator 108 to generate a haptic output at the input region in response to the activation of the virtual keyboard. In one example, controller 110 may determine that the first virtual key is configured as a default key to generate the haptic output in response to the activation of the virtual keyboard. Then, controller 110 may trigger first actuator 108 corresponding to the determined first virtual key to generate the haptic output at the input region.

Thus, first actuator 108 may generate the haptic output having a haptic frequency and amplitude at the input region to indicate a typing location of the first virtual key. In this example, the haptic output may facilitate a user to sense the typing location of the first virtual key and type on the virtual keyboard without looking at the virtual keyboard.

FIG. 1B is a cross sectional view of example electronic device 100 of FIG. 1A, depicting additional features. For example, similarly named elements of FIG. 1B may be similar in structure and/or function to elements described with respect to FIG. 1A. As shown in FIG. 1B, touch panel 102 may include a transparent substrate 152 that forms an outermost surface of electronic device 100. Example transparent substrate 152 may be a tempered glass. Further, touch panel 102 may include a touch sensor layer 154 disposed on a lower surface of transparent substrate 152.

Further, haptic array module 106 may include a flexible circuit board 156 disposed below display panel 104 and electrically connected to controller 110. Example flexible circuit board 156 may be a printed circuit board. Further, flexible circuit board 156 may be electrically connected to controller 110, for instance, via a flexible cable 164. As shown in FIG. 1B, first actuator 108 may be disposed on flexible circuit board 156 corresponding to the input region. During operation, first actuator 108 may generate the haptic output on an upper surface of transparent substrate 152 corresponding to the input region. For example, the upper surface of transparent substrate 152 may form input surface 112 of touch panel 102.

FIG. 1C depicts an exploded view of example electronic device 100 of FIGS. 1A and 1B, depicting an example virtual keyboard. As shown in FIG. 1C, display panel 104 may display an image of a set of virtual keys (e.g., 158A-158H) within a defined region. Further, the set of virtual keys may be arranged in a defined layout (e.g., a QWERTY layout).

Further as shown in FIG. 1C, multiple actuators (e.g., 108A-108H) may be disposed on flexible circuit board 156. In this example, each actuator may be disposed corresponding to one virtual key. For example, actuator 108A may be disposed corresponding to virtual key 158A, actuator 108B may be disposed corresponding to virtual key 158B, and the like.

In one example, consider that virtual keys 158A-158H may be configured as default keys to generate the haptic output. In this example, controller 110 may simultaneously trigger actuators 108A-108H corresponding to virtual keys 158A-158H, respectively, to generate the haptic output at input regions corresponding to virtual keys 158A-158H, for instance, in response to the activation of the keyboard. Thus, when the operating system pops up the virtual keyboard on display panel 104, actuators 108A-108H disposed below virtual keys 158A-158H (e.g., ASDF keys as shown by dotted line 160A and “JKL;” keys as shown by dotted line 160B) may enter a pre-vibration mode to create a surface texture for users to identify typing/reference locations of virtual keys 158A-158H.

When the user feels the surface texture on the “ASDF” and “JKL:” keys by fingertip, the user can type on the virtual keyboard without looking at the virtual keyboard. In this example, the “ASDF” and “JKL:” keys may be configured as default keys to generate the haptic output, for instance, during manufacturing stage of electronic device 100. However, the virtual keys to generate the haptic output can be configurable according to a user preference as shown in FIG. 1D.

FIG. 1D depicts an exploded view of example electronic device 100 of FIG. 1C, depicting customization of the virtual keys according to the user preference to generate the haptic output. Considering that each user may have a different typing habit or different typing location. In such a scenario, controller 110 may provide an option to facilitate the user to define the virtual keys to generate the haptic output.

In the example shown in FIG. 1D, consider that virtual keys 1581-158P may be selected by the user to generate the haptic output. In this example, controller 110 may trigger actuators 1081-108P corresponding to virtual keys 1581-158P, respectively, to generate the haptic output at the input regions corresponding to virtual keys 1581-158P, for instance, in response to the activation of the virtual keyboard. Thus, when the operating system pops up the virtual keyboard on display panel 104, actuators 1081-108P disposed below virtual keys 1581-158P (e.g., “QWEF” keys and “JIOP” keys) may enter the pre-vibration mode to create a surface texture for users to identify typing/reference locations of virtual keys 1581-158P. Thus, examples described herein can customize the virtual keys according to the user preference to generate the haptic output.

In other examples, the keyboard region can be divided into a first area and a second area that is different from the first area. The first area may include a first group of virtual keys and the second area may include a second group of virtual keys. For example, the first group of virtual keys can be selected by a user's left hand and the second group of virtual keys can be selected by the user's right hand. In this example, controller 110 may include a first control portion 162A to control the first group of virtual keys and a second control portion 162B to control the second group of virtual keys.

Further, flexible circuit board 156 may be electrically connected to first control portion 162A, for instance, via a flexible cable 164A. Further, flexible circuit board 156 may be electrically connected to second control portion 162B, for instance, via a flexible cable 164B. For example, first control portion 162A may trigger a first actuator (e.g., 1081) corresponding to a virtual key (e.g., 1581) in the first group of virtual keys. Further, second control portion 162B may trigger a second actuator (e.g., 108M) corresponding to a virtual key (e.g., 158M) in the second group of virtual keys. In some examples, first control portion 162A and second control portion 162B may simultaneously trigger first actuator 1081 and second actuator 108M based on the user preference. In other examples, first actuator 1081 and second actuator 108M may produce different haptic outputs, such as vibrations in different directions.

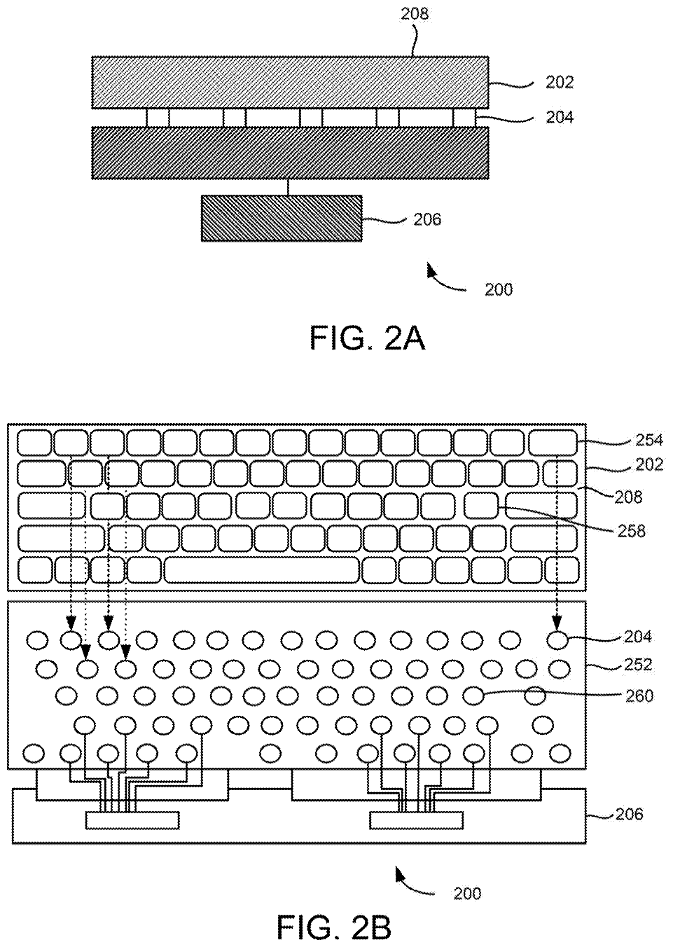

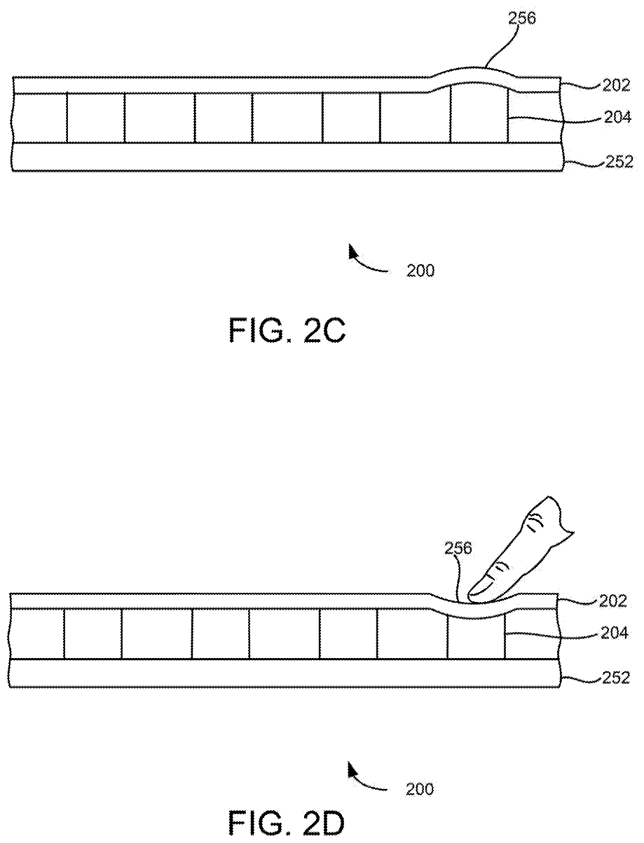

FIG. 2A is a cross sectional view of an example electronic device 200, including a controller 206 to trigger a first actuator 204 to generate a first haptic output at a first key. Example electronic device 200 may include a dual-screen notebook computer, foldable display device, or the like. In other examples, electronic device 200 may be a keyboard having a flat, keyless input surface, such as a glass or metal layer, and may include touch and/or force sensing components to determine a touch input on the keyless input surface.

Example electronic device 200 may include a touch screen 202 defining a keyboard including a set of keys. Touch screen 202 may include an input surface 208 having an input region. Further, electronic device 200 may include first actuator 204 disposed below the input region corresponding to a first key of the set of keys. For example, first actuator 204 may be a piezoelectric actuator. Furthermore, electronic device 200 may include controller 206 in communication with first actuator 204. Controller 206 may be implemented as engines or modules including any combination of hardware and programming to implement the functionalities described herein. For example, controller 206 can be implemented with a microcontroller, an application-specific integrated circuit (ASIC), a programmable gate array (PGA), or the like.

During operation, controller 206 may retrieve a user profile including key information for generating a first haptic output. In one example, controller 206 may retrieve the user profile in response to detecting an input force applied on the keyboard is less than or equal to a threshold. In another example, controller 206 may retrieve the user profile in response to detecting a proximity of a hand to the keyboard on touch screen 202. In yet another example, controller 206 may retrieve the user profile in response to an activation of the keyboard. Further, controller 206 may trigger first actuator 204 corresponding to the first key to generate the first haptic output at the input region based on the user profile.

FIG. 2B depicts an exploded view of example electronic device 200 of FIG. 2A, depicting an example keyboard. For example, similarly named elements of FIG. 2B may be similar in structure and/or function to elements described with respect to FIG. 2A. In one example, input surface 208 of touch screen 202 may be a planar surface. In this example, the keyboard may be defined on the planar surface to receive a touch input. In another example, touch screen 202 may include a display portion to display an image of the keyboard within a defined region.

As shown in FIG. 28, electronic device 200 may include a flexible circuit board 252 disposed below touch screen 202 and electrically connected to controller 206. In this example, first actuator 204 is disposed on flexible circuit board 252 corresponding to the input region. Further as shown in FIG. 28, the input region may correspond to first key 254 of the set of keys.

During operation, controller 206 may detect an input force applied on the keyboard. Further, controller 206 may bigger first actuator 204 to generate the first haptic output at the input region based on the user profile when the input force applied on the keyboard is less than or equal to a threshold. In this example, the user profile may provide the key information to generate the first haptic output. The first haptic output may provide a surface texture on input surface 208 over first key 254 indicating a location of the input region.

In another example, controller 206 may trigger first actuator 204 to generate a second haptic output at the input region when the input force applied on the input region is greater the threshold. The second haptic output may be different from the first haptic output, i.e., the second haptic output may include a haptic frequency and amplitude that is different from the first haptic output. The second haptic output may simulate a behavior of a physical key, i.e., induce a sensation representative of pressing the physical key. The first haptic output and the second haptic output may deform a surface of the input region that can be felt by a finger directly on the deformed input region.

In some examples, controller 206 may apply a first voltage to first actuator 204 corresponding to first key 254 when the input force applied on the keyboard is less than or equal to a threshold. In this example, first actuator 204 may generate the first haptic output (e.g., a surface texture) at the input region corresponding to first key 254 upon applying the first voltage. FIG. 2C illustrates an example schematic diagram of a portion of electronic device 200, depicting first actuator 204 to locally deform input region 256 of touch screen 202 over first key (e.g., 254 as shown in FIG. 2B). For example, similarly named elements of FIG. 2C may be similar in structure and/or function to elements described with respect to FIGS. 2A and 2B. In this example, first actuator 204 may raise input region 256 over first key 254 so that the user may be able to perceive that a finger is touching first key 254, e.g. “K” key, without looking at touch screen 202.

Further, controller 206 may apply a second voltage different from the first voltage to first actuator 204 when the input force applied on the input region is greater the threshold. The threshold may correspond to a force associated with a typing input (i.e., indicative of a key press) on the input region. In this example, first actuator 204 may generate the second haptic output at an input region corresponding to first key 254 upon applying the second voltage. As shown in FIG. 2D, when the finger continues to press downward, first actuator 204 may allow the input region 256 to move downward as depicted. For example, similarly named elements of FIG. 2D may be similar in structure and/or function to elements described with respect to FIGS. 2A, 2B, and 2C. Once the finger moves a threshold distance or releases downward pressure, first actuator 204 may cause input region 256 to move upward again, for instance either returning input region 256 to an original position or moving further upward, thereby providing to a user the sensation of a click or motion similar to a physical key or button press.

Electronic device 200 may include a third input region on input surface 208 and a third actuator 260 disposed below the third input region corresponding to a third key 258. In this example, controller 206 may trigger first actuator 204 and third actuator 260 to simultaneously generate the first haptic output corresponding to the first input region and the third input region, respectively, based on the user profile.

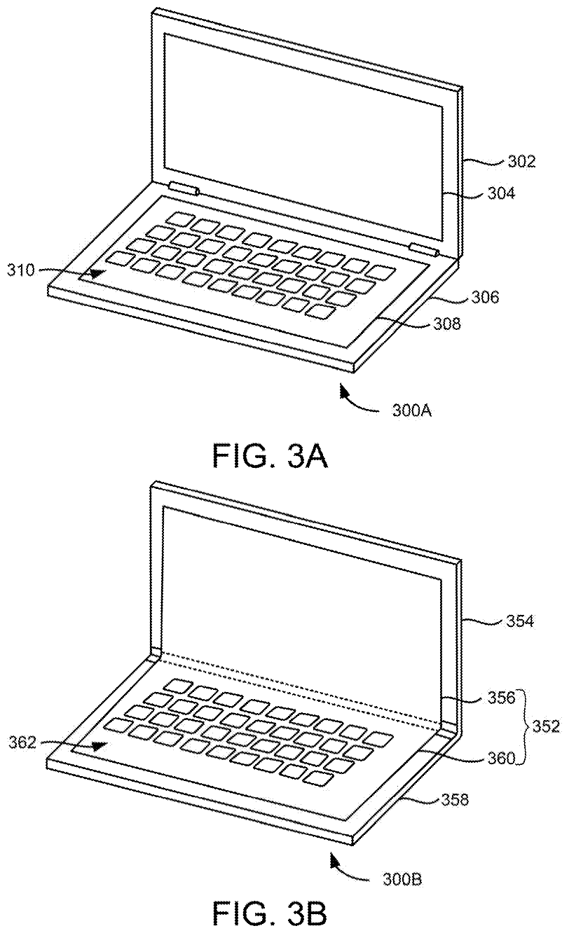

FIG. 3A illustrates a schematic diagram of an example electronic device 300A (e.g., such as electronic device 200 shown in FIG. 2A), including dual screens to implement functionalities described in FIG. 2A. As shown in FIG. 3A, electronic device 300A may include a first housing 302 having a first display 304. Further, electronic device 300A may include a second housing 306 rotatably coupled to first housing 302, for instance, via a hinge. First housing 302 and second housing 306 may be coupled to one another such that they can be positioned in an open position and a closed position. Second housing 306 may serve as a base member and include a second display 308 including touch screen (e.g., 202 as shown in FIG. 2A). In this example, second display 308 may display an image of a keyboard 310 within a defined region. Keyboard 310 may include a set of keys to provide the first haptic output as described in FIG. 2A. In other examples, second display 308 may also display an image of a trackpad.

FIG. 3B illustrates a schematic diagram of an example electronic device 300B (e.g., such as electronic device 200 shown in FIG. 2A), including a foldable display to implement the functionalities described in FIG. 2A. Electronic device 300B may include a foldable display 352. In one example, electronic device 300B may include a first housing 354 having a first display portion 356 of foldable display 352. Further, electronic device 300B may include a second housing 358 rotatably coupled to first housing 354. Second housing 358 may include a second display portion 360 of foldable display 352. In this example, second display portion 360 may include the touch screen (e.g., 202 as shown in FIG. 2A) and display an image of a keyboard 362 within a defined region.

Foldable display 352 may conform to a folded housing and bend as first housing 354 and second housing 358 may be rotated relative to each other. In this example, first display portion 356 may present content, while second display portion 360 may present keyboard 362 to accept user inputs. Keyboard 362 may include a set of keys to provide the first haptic output as described in FIG. 2A.

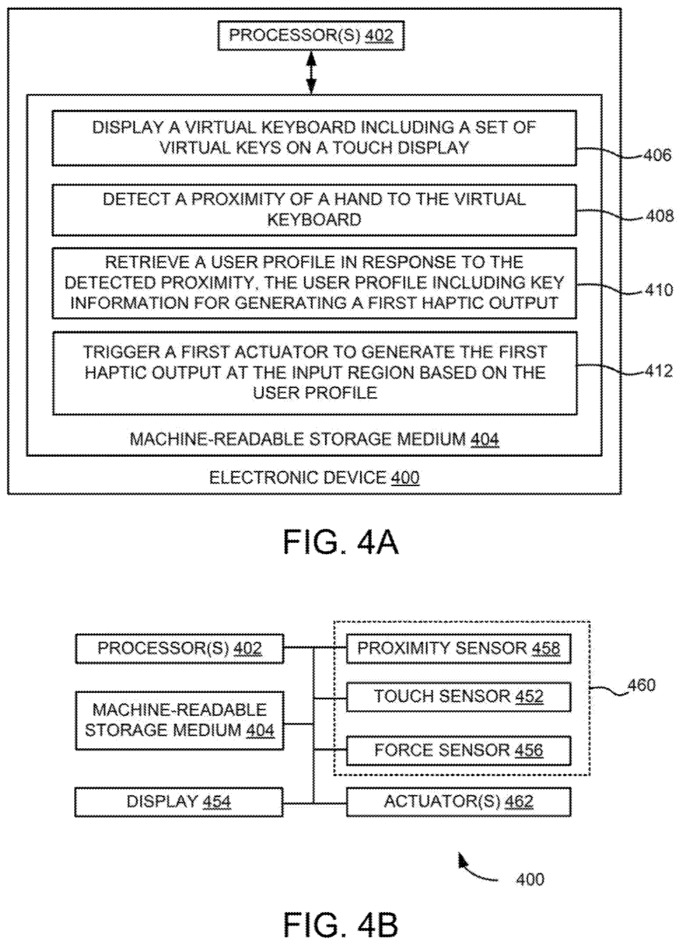

FIG. 4A is a block diagram of an example electronic device 400 including a non-transitory machine-readable storage medium 404, storing instructions (e.g., 406 to 412) to trigger a first actuator to generate a first haptic output at an input region based on a user profile. Electronic device 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to electronic device 400.

As shown in FIG. 4A, machine-readable storage medium 404 may store instructions 406-412. In an example, instructions 406-412 may be executed by processor 402 to trigger the first actuator to generate the first haptic output. Instructions 406 may be executed by processor 402 to display a virtual keyboard including a set of virtual keys on a touch display. The touch display may define an input surface having an input region.

Instructions 408 may be executed by processor 402 to detect a proximity of a hand to the virtual keyboard, i.e., the hand approaching the virtual keyboard. In this example, instructions to detect the proximity of the hand to the virtual keyboard may include instructions to detect the proximity of the hand to the virtual keyboard via a proximity sensor of electronic device 400.

Instructions 410 may be executed by processor 402 to retrieve a user profile in response to the detected proximity. In one example, the user profile may include key information for generating a first haptic output. In this example, the key information is defined based on a user preference. For example, processor 402 may receive, via a user interface, a selection of a first virtual key as the key information to generate the first haptic output. Further, processor 402 may generate the user profile to include the key information and store the user profile in machine-readable storage medium 404. During operation, processor 402 may retrieve the user profile from machine-readable storage medium 404 in response to the detected proximity.

Instructions 412 may be executed by processor 402 to trigger the first actuator, disposed below the input region corresponding to the first virtual key, to generate the first haptic output at the input region based on the user profile. Machine-readable storage medium 404 may further store instructions to detect a touch input applied to the first virtual key. Further, machine-readable storage medium 404 may store instructions to trigger the first actuator to generate a second haptic output at the input region in response to detecting the touch input applied to the first virtual key. The second haptic output may be different from the first haptic output.

FIG. 4B is a block diagram of example electronic device 400 of FIG. 4A, depicting additional features. For example, similarly named elements of FIG. 4B may be similar in structure and/or function to elements described with respect to FIG. 4A. As shown in FIG. 48, electronic device 400 may include processor 402 that can access machine-readable storage medium 404 having instructions stored thereon. The instructions or computer programs may be configured to perform the operations or functions described with respect to FIG. 4A.

Electronic device 400 may include a touch sensor 452 to detect a touch-input and generate signals or data that can be accessed using processor instructions. Touch sensor 452 may use any suitable components and may rely on any suitable phenomena to detect physical inputs. For example, touch sensor 452 may be a capacitive touch sensor, a resistive touch sensor, an acoustic wave sensor, or the like. Touch sensor 452 may be used in conjunction with various input mechanisms to detect various types of inputs. For example, touch sensor 452 may be used to detect the touch input (e.g., gestures, multi-touch inputs, taps, and the like), keyboard inputs (e.g., actuations of mechanical or virtual keys), and the like. Touch sensor 452 may be integrated with or otherwise configured to detect the touch input applied to a top surface of a display 454 of electronic device 400. Touch sensor 452 may operate in conjunction with a force sensor 456 to generate signals or data in response to the touch input.

Electronic device 400 may include force sensor 456 to detect a force-based input and generate signals or data that can be accessed using processor instructions. The force sensors 456 may use any suitable components and may rely on any suitable phenomena to detect physical inputs. For example, force sensor 456 may be strain-based sensors, piezoelectric-based sensors, piezoresistive-based sensors, capacitive sensors, resistive sensors, or the like. Force sensor 456 may be used in conjunction with various input mechanisms to detect various types of inputs. For example, force sensor 456 may be used to detect touches, clicks, presses, or other force inputs applied to a keyboard, an input region of a virtual key, a touch- or force-sensitive input region, or the like, any or all of which may be located on or integrated with the top surface of display 454. Force sensor 456 may be configured to determine a magnitude of a force input (e.g., representing an amount of force along a graduated scale, rather than a mere binary “force/no-force” determination). Force sensor 456 and/or associated circuitry may compare the determined force magnitude against a threshold value to determine what, if any, action to take in response to the force input. As described herein, force thresholds may be selected dynamically or otherwise changed based on the location of the input, whether a user's palms are detected resting on the top case, or any other suitable factor(s). Force sensor 456 may operate in conjunction with touch sensor 452 to generate signals or data in response to touch- and/or force-based inputs.

Furthermore, electronic device 400 may include a proximity sensor 458 to detect a touch-input and generate signals or data that can be accessed using processor instructions. Proximity sensor 458 may use any suitable components and may rely on any suitable phenomena to detect proximity data. For example, proximity sensor 458 may be a touch sensor, camera sensor, laser, or the like. Proximity sensor 458 may be used in conjunction with various input mechanisms to detect a presence of objects (e.g., user's hand) within a vicinity without any physical contact. For example, proximity sensor 458 may be used to detect a proximity of the user's hand to a virtual keyboard, and the like. Proximity sensor 458 may be integrated with or otherwise configured to detect the proximity data to a top surface of display 454. Proximity sensor 458 may operate in conjunction with touch sensor 452 and/or force sensor 456 to generate signals or data in response to detecting the proximity of the user's hand.

Touch sensor 452, force sensor 456, and proximity sensor 458 may be considered as a part of a sensing unit 460. Sensing unit 460 may include touch sensor 452, force sensor 456, proximity sensor 458, or any combination thereof. Further, the sensing unit 460 may provide proximity sensing functions, touch sensing functions, and/or force sensing functions using any configuration or combination of hardware and/or instructions, systems, subsystems, and the like.

Also, electronic device 400 may include an actuator 462. Actuator 462 may include a variety of haptic technologies such as a piezoelectric element, a vibration element, and so on. During operation, actuator 462 may provide a first haptic output or a second haptic output. Such haptic outputs may be provided in response to detection of a proximity of user's hand, a touch input, a force input, an activation of the virtual keyboard, or the like. Haptic outputs may be imparted to a user through various physical components, such as a top surface of display 454.

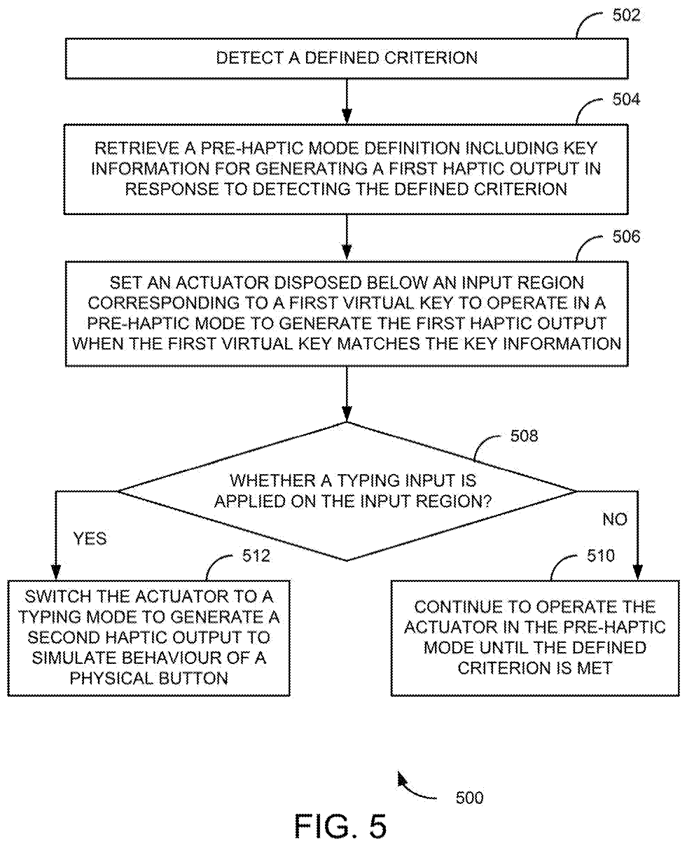

FIG. 5 is an example flow diagram 500 for switching an actuator corresponding to a first virtual key between a typing mode and a pre-haptic mode. At 502, a defined criterion to generate a first haptic mode may be detected. For example, detecting the defined criterion may include detecting an activation of a virtual keyboard of an electronic device, detecting an input force applied on the virtual keyboard is less than or equal to a threshold, or detecting a proximity of a hand to the virtual keyboard.

At 504, a pre-haptic mode definition including key information for generating a first haptic output may be retrieved in response to detecting the defined criterion. The key information may include a default key or a user-defined key. At 506, an actuator disposed below an input region corresponding to the first virtual key may be set to operate in a pre-haptic mode when the first virtual key matches the key information. In the pre-haptic mode, the actuator may generate the first haptic output until the defined criterion is met, for instance, until the hand is in proximity to the virtual keyboard. The first haptic output may have a haptic frequency and amplitude at the input region. In this example, the user may be able to perceive that a finger is touching the first virtual key without looking at the virtual keyboard.

At 508, a check is made to determine whether a typing input is applied on the input region. If the typing input is not applied, the actuator may be continued to operate in the pre-haptic mode until the defined criterion is met, at 510. If the typing input is applied, the actuator may be switched to a typing mode to generate a second haptic output to simulate behaviour of a physical button, at 512. Thus, examples described herein may switch the actuator to trigger between the typing mode and the pre-haptic mode. Also, examples described herein may enhance user experience to operate the virtual keyboard on foldable display devices or dual screen display devices as users may avoid having to look at a display while typing on the virtual keyboard on the display.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An electronic device comprising:
a touch panel defining an input surface having an input region;
a display panel disposed below the touch panel, wherein the display panel is to visualize a virtual keyboard including a set of virtual keys;
a haptic array module disposed below the display panel, wherein the haptic array module comprises:
a first actuator disposed below the input region corresponding to a first virtual key of the set of virtual keys; and
a controller in communication with the haptic array module to trigger the first actuator to generate a haptic output at the input region in response to an activation of the virtual keyboard.

2. The electronic device of claim 1, wherein the first actuator is to generate the haptic output having a haptic frequency and amplitude at the input region to indicate a location of the first virtual key.

3. The electronic device of claim 1, wherein the touch panel comprises:
a transparent substrate; and
a touch sensor layer disposed on a lower surface of the transparent substrate, wherein the first actuator is to generate the haptic output on an upper surface of the transparent substrate corresponding to the input region.

4. The electronic device of claim 1, wherein the controller is to:
determine that the first virtual key is configured as a default key to generate the haptic output in response to the activation of the virtual keyboard; and
trigger the first actuator corresponding to the determined first virtual key to generate the haptic output at the input region.

5. The electronic device of claim 1, wherein the haptic array module comprises:
a flexible circuit board disposed below the display panel and electrically connected to the controller, wherein the first actuator is disposed on the flexible circuit board corresponding to the input region.

6. An electronic device comprising:
a touch screen defining a keyboard including a set of keys, wherein the touch screen includes an input surface having an input region;
a first actuator disposed below the input region corresponding to a first key of the set of keys; and
a controller in communication with the first actuator, wherein the controller is to:
retrieve a user profile including key information for generating a first haptic output; and
trigger the first actuator corresponding to the first key to generate the first haptic output at the input region based on the user profile.

7. The electronic device of claim 6, wherein the first actuator is a piezoelectric actuator.

8. The electronic device of claim 6, wherein the input surface is a planar surface, and wherein the keyboard is defined on the planar surface.

9. The electronic device of claim 6, further comprising:
a first housing comprising a first display portion; and
a second housing rotatably coupled to the first housing, wherein the second housing comprises a second display portion including the touch screen, and wherein the second display portion is to display an image of the keyboard within a defined region.

10. The electronic device of claim 6, wherein the controller is to:
detect an input force applied on the keyboard; and
trigger the first actuator to generate the first haptic output at the input region based on the user profile when the input force applied on the keyboard is less than or equal to a threshold.

11. The electronic device of claim 10, wherein the controller is to:
trigger the first actuator to generate a second haptic output at the input region when the input force applied on the input region is greater the threshold, the second haptic output is different from the first haptic output.

12. A non-transitory machine-readable storage medium encoded with instructions that, when executed by a processor of an electronic device, cause the processor to:
display a virtual keyboard including a set of virtual keys on a touch display, the touch display defining an input surface having an input region;
detect a proximity of a hand to the virtual keyboard;
retrieve a user profile in response to the detected proximity, wherein the user profile includes key information for generating a first haptic output; and
trigger a first actuator, disposed below the input region corresponding to a first virtual key of the set of virtual keys, to generate the first haptic output at the input region based on the user profile.

13. The non-transitory machine-readable storage medium of claim 12, wherein instructions to detect the proximity of the hand to the virtual keyboard comprise instructions to:
detect the proximity of the hand to the virtual keyboard via a proximity sensor of the electronic device.

14. The non-transitory machine-readable storage medium of claim 12, further comprising instructions to:
detect a touch input applied to the first virtual key; and
trigger the first actuator to generate a second haptic output at the input region in response to detecting the touch input applied to the first virtual key, wherein the second haptic output is different from the first haptic output.

15. The non-transitory machine-readable storage medium of claim 12, comprising instructions to:
receive, via a user interface, a selection of the first virtual key as the key information to generate the first haptic output; and
generate the user profile to include the key information.
